(19) United States
(12) Patent Application Publication
(10) Pub. No.: US 2026/0212740 A1
(43) Pub. Date: Jul. 23, 2026

(54) A SECURITY DEVICE

(71) Applicant: GEOTEKK LTD, Norwich Norfolk (GB)

(72) Inventors: James Sheppard, Norwich (GB); Matthew Leach, Norwich Norfolk (GB); Steven Legon, Norwich Norfolk (GB)

(21) Appl. No.: 19/138,553

(22) PCT Filed: Dec. 12, 2023
(86) PCT No.: PCT/GB2023/053194

§ 371 Date: Jun. 12, 2025

(30) Foreign Application Priority Data
Dec. 12, 2022 (GB) 2218652.2
Aug. 24, 2023 (GB) 2312921.6

(51) Int. Cl. G08B 13/14; G08B 15/02; G08B 25/10; H01Q 1/22; H01Q 1/42

(52) U.S. Cl. CPC G08B 13/1472; G08B 15/02; G08B 25/10; H01Q 1/22; H01Q 1/42

(57) ABSTRACT

A security device (100) is configured to be secured to an object (300). A mount (200) is configured to be mounted with the security device (100), and further configured to be secured to the object (300). An enclosure (110) of the security device (100) is strong enough to protect its electronic components (121b, 122, 123, 124b). A backup antenna (121b, 124b) is located inside of the enclosure (110). A main antenna (121a, 124a) that is located outside of the enclosure (110). A cover (130) is configured to protect the main antenna (121a, 124a). The cover (130) is transparent to radio waves.

### TECHNICAL FIELD

This disclosure relates to a security device, and in particular relates to the technical field of theft prevention for movable equipment such as vehicles.

### BACKGROUND

Traditional locks can be easily be overcome by thieves, risking the theft of valuable objects. Attempts to slow down a thief include making the locks more difficult to compromise by force, which is typically achieved by manufacturing locks from high strength materials such as steel. Locks such as heavy-duty chains or ‘D-locks’ are used to protect vehicles such as bicycles and motorbikes. These locks are heavy, and can be difficult to transport, and also fail to alert the owner in the event of an attempted theft.

A balance is to be found between the strength of the lock and the weight of the lock, particularly if the lock is to be carried around by the owner of the object. To protect vehicles, there is a demand for a lock that will be light enough to avoid disrupting the balance of the vehicle during transportation, and strong enough to secure the vehicle once its owner has reached their destination.

A further way to protect property is to include a deterrent such as an audible alarm, which draws attention of the public in the event that an attempted theft is detected. There is an incentive for thieves to damage deterrents or remove them from the object. Therefore, thieves often equip themselves with tools which they use to damage security devices. It's typical for deterrents to be protected using high strength materials, although this protection further adds to the weight of the security device.

A known way for owners to keep track of their property is to install it with a tracking chip which emits its location to a mobile device which is in the possession of the owner. Tracking chips are known which receive location information from Global Positioning Satellites (GPS), and communicate this position to the mobile device. However, tracking chips are often easy to remove, and are vulnerable to being damaged, which limits their effectiveness at stopping crime. Thieves often try to destroy tracking devices so that the position of the object is no longer be monitored. Therefore, there is a desire to find ways to prevent damage to tracking devices which are installed to monitor the status of valuable property. Electronic components are fragile, and so should be protected from tools that are used by thieves. Furthermore, the tracking device should be securely mounted to the object that is to be monitored, so that after a theft has taken place, it can continue to detect and report the position of the object.

A problem solved by the present innovation is how to provide a hardcore mechanical lock with integrated delicate IoT circuitry, which is exposed to attack from a potential thief (like a padlock). The security device acts as a visual deterrent, whilst allowing both the lock and antennas to operate effectively. There is a demand for a smart lock that is keyless (not requiring a physical key like used on a padlock) and instead is operated via a user app for locking/unlocking the security device.

There is a demand for a security device having a lock that incorporates strong material (e.g., metals) in order to provide enough strength. However, IoT technology implements delicate circuity and antennas, and these antennas cannot transmit through metals. Accordingly, innovation is to be found to provide an innovative solution for protecting the electronic components whilst permitting transmission of alert signals.

Accordingly, there is a demand for security devices that have the capability to deter, detect and delay attempts steal an object that is being protected. Innovation is to be found in the ways in which the security device protects valuable objects:
by providing an effective visual deterrent that prevents theft from happening,
by providing instant alert notifications that allow their owner to initiate a swift response to a threat, and
by providing a layer of security that completely thwarts or prolongs any attack.

Disclosure is provided of a security device that has been designed to address these problems.

### SUMMARY

Aspects of the present invention are set out by the claims. Further aspects are also described.

An advantages of the disclosed arrangements is to provide a way of combining metals, IoT circuitry, and most importantly, radio wave connectivity. This may be achieved by having a main circuit board and a locking pin within a steel bunker. Antennas outside the steel bunker can be protected by an aramid cup, which is permanently glued to the sides of bunker making all parts act as one system. This lock does not require a physical key, with an app being used to lock and unlock the device. Advantageously, protection is provided to both the main circuit board and the locking pin within a unique bunker.

As a first aspect, disclosure is provided of a security device configured to be secured to an object. The security device comprises: an enclosure which is configured to protect electronic components of the security device; a backup antenna that is located inside of the enclosure; a main antenna that is located outside of the enclosure; and a cover configured to protect the main antenna, wherein the cover is transparent to radio waves. The cover allows the transfer of signals between antennas of the security device and a user's mobile device, which allows the user to receive alert messages from the security device. The enclosure has a strength profile that ensures that the electronic components can withstand an attack. The enclosure serves as a bunker, which protects electronic components of the security device, such as the backup antenna. Communication is enhanced by providing the main antenna outside of the enclosure, which is protected by the cover. The strength of the enclosure is higher than the strength of the cover, and so the enclosure contributes a further defence that prevents the electronic components from being accessed during an attack.

The main antenna and the backup antenna each includes a sensor configured to sense a status of the security device, and a transmitter configured to transmit the alarm signal to a mobile device. Thus, the main antenna and the backup antenna can each communicate with a mobile device that is in the possession of the owner of the security device, to provide an alarm signal in the event of an attack. The alert may be sent directly from the security device to the mobile device, although typically, the device will communicate with a backend platform (which may be cloud-based), with the backend platform sending the alert to the user's mobile device. The antennas each include a sensor and a transmitter. The sensors of the antennas are used to determine the location of the device, and thus serve to sense a status of the security device, because they provide for an assessment to be made of whether the security device has been moved. In addition to the sensors of the antennas, the security device may include other types of sensors (e.g., an accelerometer, a camera, a thermal sensor). For example, the security device may include an accelerometer, which may function to detect impact forces being received by the security device. Optionally, the cover comprises a composite material. The composite material is formed from a number of layers of material and an adhesive. Using a composite material allows the strength profile to be selected, while also being light in weight. A cover formed from composite materials protects electronic components housed within it, while allowing communication signals to be transmitted. The composite material may be manufactured by pressing together these layers and adhesive, to achieve a cover having a high strength-to-weight ratio. The cover is configured to stop projectiles and absorb the kinetic energy of the projectile. The cover can therefore protect antennas in a security device, because this part is both radio-transmissible, strong and light. The cover is designed to protect the antennas long enough for them to transmit an attack alert to the owner in the event of an attack. The duration to send an alert is likely to be less than 5 seconds, although the part is designed to last much longer before it is deformed to such an extent that the antennas can no longer function—dependent on the intensity of the attack, up to several minutes, or even indefinitely in the event of an unsophisticated attack. In terms of force, the strength profile of the cover is sufficient to survive an attack of any force that can reasonably be applied/executed by a human wielding/using handheld tools (i.e. the cover is capable of surviving an attack from a tool designed such that all energy/force comes from human implementation). The composite material may be aramid or UHMWPE (ultra high molecular weight polyethylene).

Optionally, the cover has a dome shape configured to resist external stress forces. A domeshaped cover confers additional strength by virtue of dissipating any impact forces that are received by the cover. Thus, a cover can be provided that protects internal electronic components from a hammer attack or similar.

Optionally, the cover may be arranged so that it will spin in the event that an attack is detected. This would make it difficult for an attacker to access the internal components of the security device. Thus, the external housing may spin if an attempt is made to cut the security device. The security device may include a bearing system, upon which the covers spin in the event of an attack. In addition, the security device may be designed so the lower housing may also spin on the attachment via a bearing system.

Optionally, the enclosure includes a hole through which the backup antenna can transmit radio waves. The backup antenna is typically protected by an enclosure formed from a material such as metal (e.g., steel) which confers strength although does not permit radio waves to be transmitted. A hole in the enclosure allows the main antenna to be electrically connected to the other electronic components. This hole serves the additional purpose of allowing radio waves to be transmitted, in order to communicate with the backup antenna. The hole is typically small, so that the enclosure provides a high degree of protection to its internal components, which restricts the range of the backup antenna.

Optionally, the enclosure comprises a filler material which prevents access to the electronic components via the hole. This filler material serves to prevent the backup antenna being attacked via the hole. The filler material has a dielectric constant that is below a threshold amount to allow radio waves to be transmitted, so that the backup antenna can be used for communication.

Optionally, the filler material includes a plurality of ceramic beads. A benefit of including ceramic beads is to add strength to the filler material. Furthermore, the ceramic beads confer resistance to drilling. The ceramic beads may be of any size.

Optionally, the main antenna is connected to the electronic components by a wire that passes through the hole. The wire serves to provide an electrical connection between electrical components that are protected by the enclosure, and the main antenna which is located outside of the enclosure.

Optionally, the security device further comprises: a first circuit board that is located outside of the enclosure, which is configured to provide an electrical connection to the main antenna; and a second circuit board that is located inside of the enclosure, which is configured to provide an electrical connection to the backup antenna. A main circuit board serves to control the operations of the device, as well as hosting the backup antenna. A secondary circuit board serves to host the main antenna. An electrical connection is provided between the main circuit board and the secondary circuit board, so that the main antenna can communicate with the control devices of the security device.

Optionally, the electronic components include: a determination unit configured to determine the status of the security device; and a control unit configured to issue an alarm signal in response to the determination unit determining the status of the security device. The security device includes an accelerometer configured to serve as a motion sensor. The status of the security device may be based on the sensor of the main antenna or on the sensor of the backup antenna. The electronic components function to trigger an alarm in the event that the security device has been attacked. Optionally, the security device further comprises: an input port configured to receive the electrical current that flows through a wire that is configured to be secured to the object. As well as ‘current’ being used to monitor the chain's integrity, it may also be possible to use a more generic ‘signal’ which is monitored, offering more security, as it's harder to manipulate. This signal may include coded information being passed down the cable. Thus, the security device can monitor an attempt to move an object that is secured by the wire. Accordingly, the security device is configured to be installed with a smart chain system that can be used to perform current monitoring. The security device can be combined with a smart chain to monitor a current around a loop. The security device can be used alongside a traditional metal chain, with the chain running through a sleeve (which contains this monitoring wire/loop) or on it's own (so the sleeve on its own with the wire inside runs through the object—a wheel for example). If a thief attempts to cut through this cable (and the chain) or to disconnect it from the security device in order to steal the item being secured, this will set off the alarm and trigger the owner alert. The cable may be supplied in a sleeve, enabling the owner to slide their chain into the sleeve. The connectors which connect to the security device and the connectors which connect together to form a complete circuit loop on the cable can be magnetic or plug-in connectors. Furthermore, it may also possible for multiple wires to connect to security device, in order to protect multiple items. These wires may connect directly to contacts on the security device or to a junction box which plugs into the security device, which enables the owner to protect/monitor multiple items.

Optionally, the input port includes a magnetic connector configured to maintain the electrical connection between the security device and the wire. For example, the input port for the smart chain may include 2×magnetic contact points on the lower housing. Charging of the security device may be achieved by a USBC port that is separate from the input port, with this USBC port being used for charging as well as firmware updates.

Optionally, the cover comprises a plurality of shells, each shell having a selected strength profile. The shells contribute in synergy, to provide the housing with a strength profile that is designed to withstand brute force attacks.

Optionally, the security device further comprises a locking mechanism configured to engage with a mount, to provide a releasable connection between the security device and the mount. Accordingly, in addition to serving as an alarm, the security device is configured to lock the security device in place, so that it remains attached to the object while it is protecting the object. Optionally, the security device and the mount are configured to be connected together by the locking mechanism, by bringing a surface of the security device into contact with a corresponding surface of the mount, and then rotating the security device relative to the mount. Thus, a simple way is provided for attaching the security device to the mount, making it easy for the user to activate the locking mechanism

Optionally, the locking mechanism is configured to release the security device from the mount, if the security device receives an instruction from the mobile device. Thus, a software application that is installed on the mobile device can be used by the owner to issue instructions for releasing the security device.

Optionally, the enclosure is configured to protect the locking mechanism. In addition to protecting the circuity and battery, the enclosure may also protect the locking mechanism (locking pin etc). Protecting the locking mechanism is valuable, because it's compromising the locking mechanism that could enable a thief to remove the security device.

Optionally, the locking mechanism comprises one or more magnets configured to engage the security device with the mount. Thus, a magnet serves as the attachment/locking mechanism. The magnet, potentially a standard magnet, an electromagnet, on/off magnet, or any other kind of magnet, is positioned on the underside of security device, enabling it to be magnetically attached to ferromagnetic materials. The magnet enables the security device to be locked to a dedicated attachment, with the magnet creating the force which is holding the device in place and preventing easy removal. The magnet can also be used to draw in a spring-loaded locking pin/actuator, from the attachment, into the underside of security device—combined with the security device's locking wings on both the underside of security device and the attachments. This prevents the device from being rotated and/or laterally removed.

Another variation of the magnetic locking mechanism is to have a magnet inside the security device holding the locking pin in place when in the unlocked position, and a magnet inside the attachment to hold the pin in place in the extended locked position. In order to drive the pin from the unlocked position to the locked position, a charge will be applied to an electromagnetic coil which surrounds the locking pin when it's in the unlocked position. This charge is strong enough to pull the pin off of the magnet in the security device, which holds the pin in place in the unlocked position, and will push the pin in to the locked position, where the magnet sitting in the attachment will hold the locking pin in place. To retract the pin in to the unlocked position, a charge is once again applied to the electromagnetic coil with the polarity reversed, which creates enough force to draw the pin off the magnet in the attachment and up to the magnet in the security device, which will hold the pin in the unlocked position. In both locking and unlocking, the charge is only applied very briefly to the coil, just enough to draw the pin off the magnet in the security device and out to the magnet in the attachment when locking, and off the magnet in the attachment and up to the magnet in the security device when unlocking. An alternative version of the locking mechanism would include a solenoid to drive the pin.

Optionally, a clamp is configured to secure the security device to a part of a vehicle. For example, the clamp is a bicycle frame clamp, which is configured to hold the bicycle seat in place on the bicycle frame. Optionally, a lock is configured to restrict movement of a component of a vehicle. For example, the lock is a throttle lock, which restricts the motion of a throttle and/or a brake lever. The mount may include both the clamp and the lock, with the clamp being configured to secure the security device to a part of the vehicle, and with the lock being configured to restrict movement of a component of the vehicle. During use of the security device for the purpose of securing the vehicle, the security device is attached to the vehicle via the mount, and/or the security device restricts motion of the component of the vehicle to prevent the vehicle from being moved by a thief. Accordingly, the security device can serve as a smart alarm, acting as a lock/immobiliser when it is combined with a separate attachment.

Optionally, the security device further comprises a power surge protector configured to prevent an electrical supply from flowing to electronic components of the security device if the power surge protector determines that the electrical supply is above a threshold value of current, voltage or power. This prevents damage to electrical components of the electrical device if it is determined that the power supply is unsafe. Thus, the security device is resilient to an attacker exposing the security device to a power surge, ensuring that the security device can continue to operate effectively with its electronics intact.

Optionally, the security device further comprises a thermal sensor configured to initiate an alert if a temperature is detected above a threshold value. Thus, the security device triggers an alarm before any of the electrical components will be compromised due to exposure to excessive heat.

Optionally, the enclosure of the security device includes a number of strips of composite material. The strips of composite material enhance the strength of the security device, increasing its resistance to attacks such as by cutting or drilling, particularly from angle grinders and drills. The composite material is low in thickness and low in weight, compared to conventional materials such as metal. Strips of composite material are added to metal parts of the security device, such as the enclosure. The strips of composite material can be added to metal parts of the security device during the casting process, or alternatively by welding the composite material to these metal parts. The use of composite material increases the security performance of the security device. Being weldable with standard welding equipment ensures a high degree of flexibility, cost efficient manufacturing and secure fastening without any specialist training in order for the security device to be manufactured. Applications of this feature include safes, locks and any other security devices. The strips of composite material may be added to the lower housing (enclosure), the throttle lock, or any other attachments.

Optionally, the security device further comprises a storage compartment configured to hold security ink that will be released if the security device (100) is attacked. Accordingly, marking security ink may be held by the device. The security ink may be held between the outer housing and the aramid cup, with the intention to physically mark an assailant if they tried to destroy/compromise the device. This makes the attacker easier to identify by the police, and so the security ink acts as an additional theft deterrent. This feature can also be integrated into attachments of the security device, in pockets of space that are in areas where an attack would be most likely to occur. As well as ink, the storage compartment may store forensic ID traceable liquids, which contain a unique forensic code that links the offender and stolen items back to the scene of the crime. This can be used by law enforcement to make a successful conviction.

As a second aspect, disclosure is provided of a security device configured to be secured to an object. The security device comprises: a sensor configured to sense a status of the security device; a determination unit configured to determine the status of the security device, based on an output of the sensor; a control unit configured to issue an alarm signal in response to the determination unit determining the status of the security device; a transmitter configured to transmit the alarm signal to a mobile device; and a housing configured to restrict access to the transmitter and further configured to allow transmission of the alarm signal through the housing, wherein the housing comprises a cover formed by pressing together a number of layers of material and an adhesive. The status of the security device can be used to infer a status of the object to which it is secured. If the status of the security device indicates a breach of security, then the alarm signal is to be transmitted to the user. A breach of security may be found occur if, for example, the security device is moved when this is unauthorised, or if the security device detects an impact force. The cover has a strength profile configured to withstand impact forces. This ensures that an attempted theft can be detected and reported before electronic components of the security device have been compromised.

Optionally, the housing further comprises a layer of fibres including fibres that are arranged loosely enough for each of the fibres to move relative to one another. If an attempt is made to drill through the housing, then the fibres will become wrapped around the drill-bit. This further contributes to protecting the electronic components, so that an attempted theft can be detected and reported. A further advantage of the layer of fibres would be to prolong an angle grinder attack, with the loose fibres getting wound round the angle grinder blade.

Optionally, the sensor is configured to monitor an electrical current that flows through a wire that is configured to be secured to the object; and the determination unit is configured to determine the status of the security device based on a change in the electrical current that is monitored by the sensor. Optionally, an input port is configured to receive the electrical current that flows through the wire that is configured to be secured to the object. Optionally, the input port is further configured to receive electrical power to charge a battery of the security device. Thus, the security device can monitor an attempt to move an object that is secured by the wire. Functions of the input port include providing electrical current from the wire to the sensor, while the object is being monitored, as well as providing electrical current to the battery for charging the security device.

Optionally, the sensor comprises a long-range antenna configured to communicate indirectly with the mobile device via a network. Thus, the alarm signal can be transmitted from the security device to a mobile device which is in the possession of the owner. Accordingly, the user is notified of an attempted theft.

Optionally, the sensor comprises a short-range antenna configured to communicate directly with the mobile device. Optionally, the short-range antenna is configured to exchange data between the security device and the mobile device; and the control unit is configured to execute an instruction received from the mobile device by the short-range antenna. Thus, the user can interact with the security device using their mobile phone. Typically, the short-range communication is used for configuring the security device, such as unlocking the device, although a possible application is for the alarm signal to be transmitted via the short-range antenna. Optionally, the sensor is configured to receive a radio signal from a global navigation satellite; the determination unit is configured to identify, from the radio signal, whether a change in a position of the security device is greater than a threshold amount; and the control unit is configured to issue the alarm signal in response to the determination unit determining that change in the position of the security device is greater than the threshold amount. This allows a geofence to establish a virtual perimeter within which the object is confined.

Optionally, the sensor comprises an accelerometer configured to detect an impact force; and the determination unit is configured to determine the status of the security device based on the impact force being above a threshold value. The accelerometer allows a hammer attack or a drill attack to be detected, so that this breach of security can be reported to the user.

Optionally, a light source is configured to indicate the status of the security device. A light can be illuminated to indicate a security breach to anyone in close vicinity to the security device.

Optionally, the cover comprises a plurality of shells, each shell having a selected strength profile. The shells contribute in synergy, to provide the housing with a strength profile that is designed to withstand brute force attacks.

Optionally, the adhesive has a dielectric constant that is low enough to allow transmission of the alarm signal through the cover. Thus, the transmission strength of the alarm signal is optimised.

Optionally, the housing comprises an enclosure configured to protect the determination unit and the control unit. The enclosure is stronger than the cover, and so locating electronic components in the enclosure provides enhanced protection from an attack. The enclosure may further include other components such as the locking mechanism, which includes actuators and motors for controlling the locking of the security device and the mount.

Optionally, the cover is configured to protect a first antenna; and the enclosure is configured to protect a second antenna, wherein the second antenna is a short-range antenna. Thus, in the event of the first antenna being damaged, the second antenna serves as a backup. This ensures that the security device can continue to communicate with the mobile device, even after the first antenna is no longer functional.

As a third aspect, disclosure is provided of a kit of parts. The kit of parts comprises: a security device according to the first aspect or the second aspect; and a mount configured to be mounted with the security device, and further configured to be secured to the object. A mount is typically provided that is customised to the object that is to be protected.

Optionally, a clamp is configured to secure the security device to a part of a vehicle. For example, the clamp is a bicycle frame clamp, which is configured to hold the bicycle seat in place on the bicycle frame. Optionally, a lock is configured to restrict movement of a component of a vehicle. For example, the lock is a throttle lock, which restricts the motion of a throttle and/or a brake lever. The mount may include both the clamp and the lock, with the clamp being configured to secure the security device to a part of the vehicle, and with the lock being configured to restrict movement of a component of the vehicle. During use of the security device for the purpose of securing the vehicle, the security device is attached to the vehicle via the mount, and/or the security device restricts motion of the component of the vehicle to prevent the vehicle from being moved by a thief.

Optionally, a locking mechanism of the security device is provided, which is configured to be received by the mount to provide a releasable connection between the security device and the mount. Accordingly, in addition to serving as an alarm, the security device is configured to lock the security device in place, so that it remains attached to the object while it is protecting the object.

Optionally, the security device and the mount are configured to be connected together by the locking mechanism, by bringing a surface of the security device into contact with a corresponding surface of the mount, and then rotating the security device relative to the mount. Thus, a simple way is provided for attaching the security device to the mount, making it easy for the user to activate the locking mechanism.

Optionally, the locking mechanism is configured to release the security device from the mount, if the security device receives an instruction from the mobile device. Thus, a software application that is installed on the mobile device can be used by the owner to issue instructions for releasing the security device. This system of devices may be referred to as, or operate as, a ‘mesh network’.

As a fourth aspect, disclosure is provided of a system of security devices, these security devices being according the first aspect or the second aspect. The security devices are configured to communicate with one another. Once of the security devices may serve as a central command. Some of the security devices of the system may serve as multiple satellite devices. The satellite devices serve to sense and/or track other valuable items and if activated, communicate with one another via radio communication (e.g., Bluetooth (registered trade mark)). The security device will than act as the broadcast beacon communicating via a backend network with the owner. Thus, the owner can have one security device monitoring many items. The security device may be linked to other external infrastructure, such as security lights and a home alarm system.

Optionally, disclosure is provided of GPS (global positioning satellite) trackers, which are capable of communicating with the security device, the backend network, and the customer.

The GPS trackers can be hidden on valuable items, and act as another layer of security alongside the security device, which acts as a visual deterrent and in some cases an immobiliser/lock. The GPS trackers can be used to track the location of valuables and aid in their recovery should they be stolen.

The composite material may be formed by the layers of material being pressed together. During manufacture, the layers of material may be pressed together at high pressure together with adhesive. Upon curing, this results in a high strength composite material that can withstand an attack. Disclosure is provided of a new and innovate solution for the consumer and the commercial electronic security device industry, by incorporating a novel and previously unexplored method step: hydraulically pressing Aramid/composite. This method step is used in military helmets and ballistic armour, although its application in electronic security devices is uncharted territory and an innovative approach, setting the disclosed innovation apart from anything else on the market.

Hydraulically pressed Aramid/composite has until now primarily been associated with military applications (military helmets and armour). Disclosure is provided of ballistic resistant technology in the consumer electronic security devices market, providing a combination of structural integrity, impact resistance, reduced weight & size, radio transparency & cost effectiveness.

An enhanced security performance can be achieved. The pressing process aligns the composite fibres in a controlled & repeatable manner. This results in a structure that is not only robust, with reduced porosity, increased compactness and density and reduced size, but is also repeatable and cost effective, making it well-suited for electronic security devices that implement radio transparency to communicate. The unique combination of ballistic resistance, lightweight, reduced size & radio transparency offers a level of protection not achieved by conventional layered and non-hydraulically pressed materials sometimes used in the electronics sector (e.g. radar domes).

Layered aramid/composites are currently utilized in applications like radar dome constructions. However, the method of hydraulic pressing has not been explored in these contexts. The innovation is not only in the use of composite materials (formed for example from Kevlar), but in the specific application of hydraulically pressed aramid (e.g., Kevlar) for electronic security devices. This differentiated the disclosed security devices from current uses. Manufacturing the device to include hydraulically pressed aramid (e.g., Kevlar) or composite helps to achieve the distinctive feature of our electronic security device. (Note that Kevlar is a registered trade mark.)

In summary, the disclosed security device redefines the current landscape of electronic security devices by introducing hydraulically pressed composite material (e.g., Kevlar) with an adhesive at controlled temperatures. The disclosed method step is previously confined only to military applications. The security device combines proven ballistic resistance with a novel application, creating an electronic security device that is unmatched in terms of structural integrity, impact resistance, radio transparency and overall performance.

### BRIEF DESCRIPTION OF THE DRAWINGS

Embodiments will now be described, by way of example only, with reference to the accompanying drawings, in which:

FIG. 1 provides a top view of a security device;

FIGS. 2A-2C illustrate an example of a security device for which a cover provides protection for one or more antenna, with FIG. 2A showing a cross section view, FIG. 2B showing an exploded view, and FIG. 2C showing a schematic view of the security device during use;

FIGS. 3A-3C illustrate another example of a security device, showing an arrangement that includes a main antenna and a backup antenna, with FIG. 3 A showing a cross section view, FIG. 3B showing an exploded view, and FIG. 3C showing a schematic view of the security device during use; FIGS. 4A-4F illustrate examples of mounts that are configured to receive the security device;

FIGS. 5A-5B illustrate the security device arranged to monitor an electrical wire that is secured to the object during use; and

FIG. 6 provides a perspective view of the security device.

### DETAILED DESCRIPTION

A security device is disclosed that during use is attached to a valuable object (e.g., a vehicle), to monitor the status of the object and report to a user if an attempt to steal it is detected. Robust hardware is provided, which combined with sophisticated communication technologies, enables the protection from theft of valuable objects (e.g., a bicycle, a motorbike, a caravan, a trailer, a horse trailer, a snowboard, a tool, a machine). A variety of sensors allow the detection of an unauthorised attempt to move the security device, with an alarm being sent to the user's mobile phone so that they can take action as soon as possible. Thus, the security device is functional as an IoT (internet of things) smart alarm as well as a tracker. Furthermore, the security device also functions as a lock when combined with certain bespoke attachments. Various exemplary embodiments, features, and aspects are described in detail below with reference to the drawings.

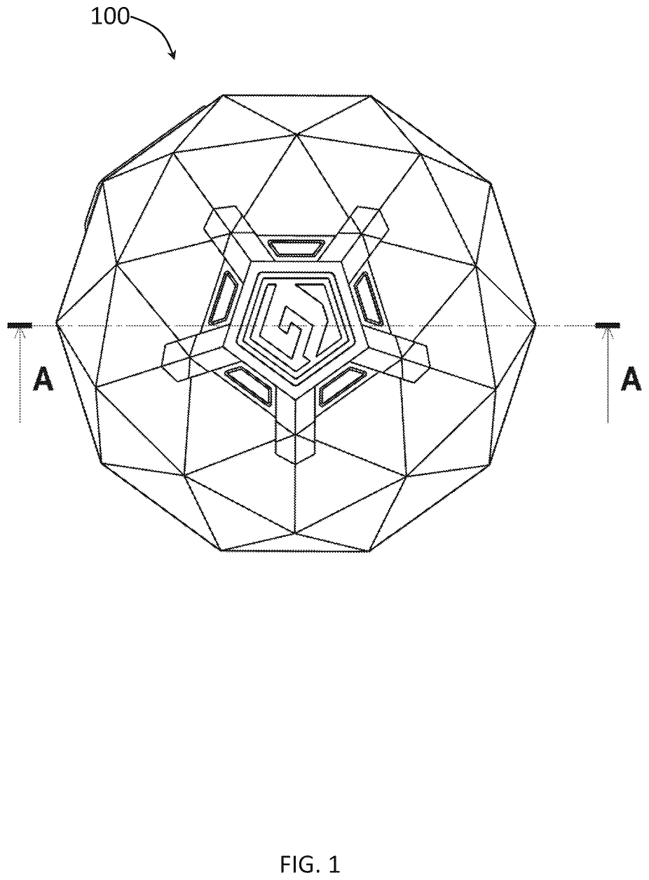

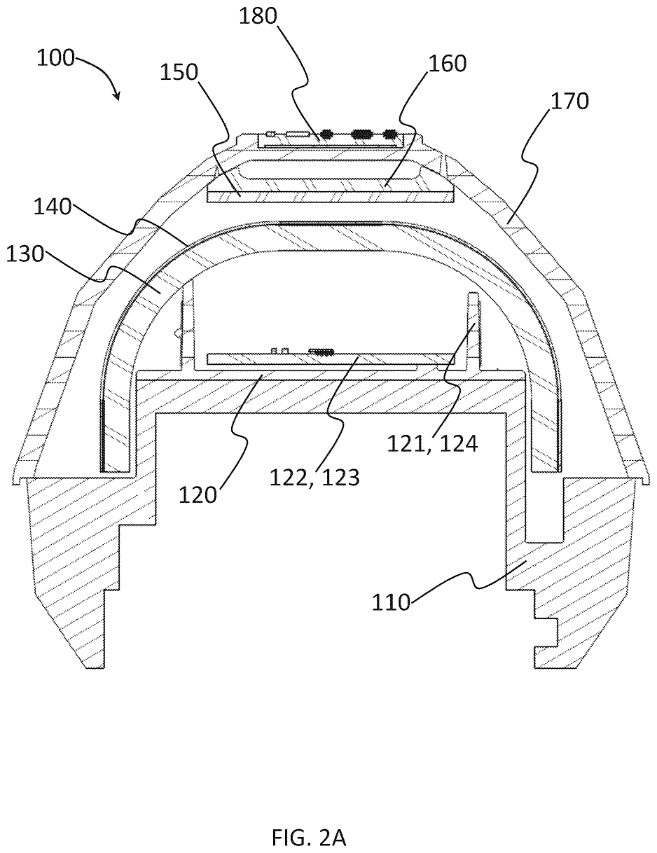

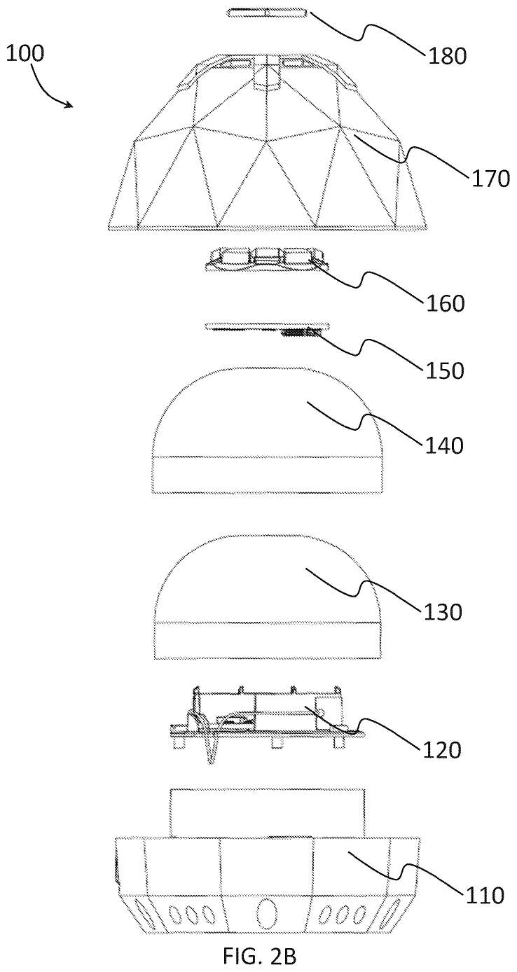

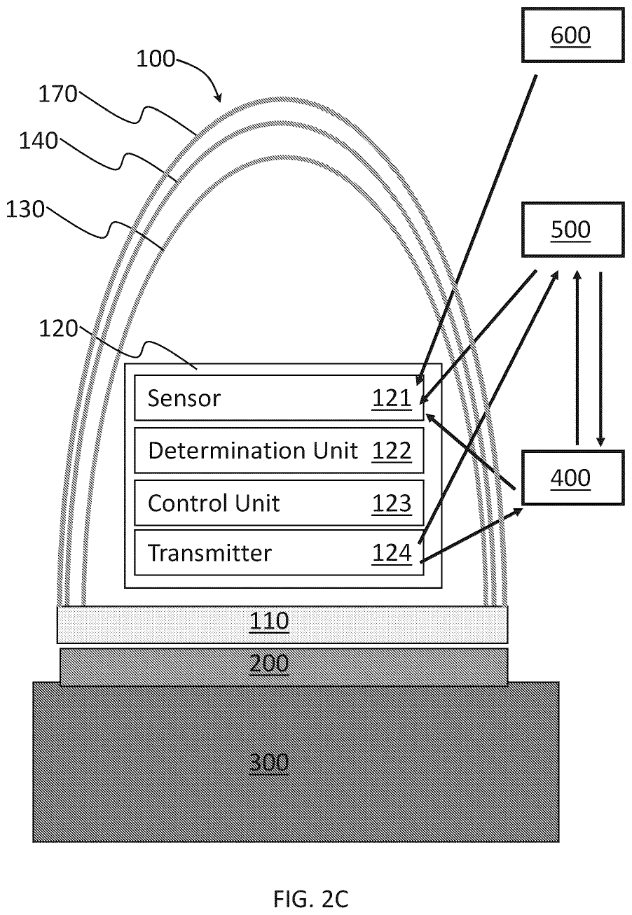

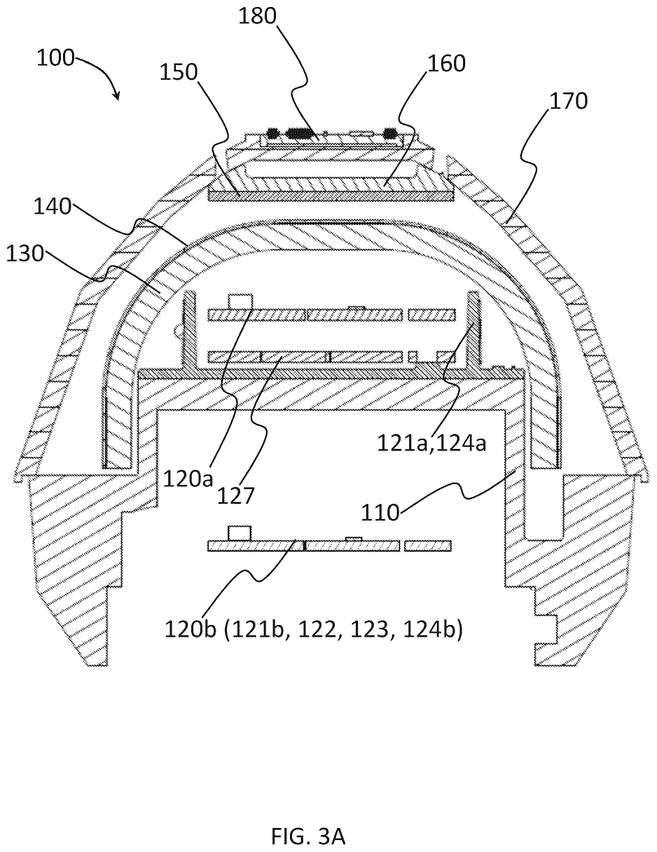

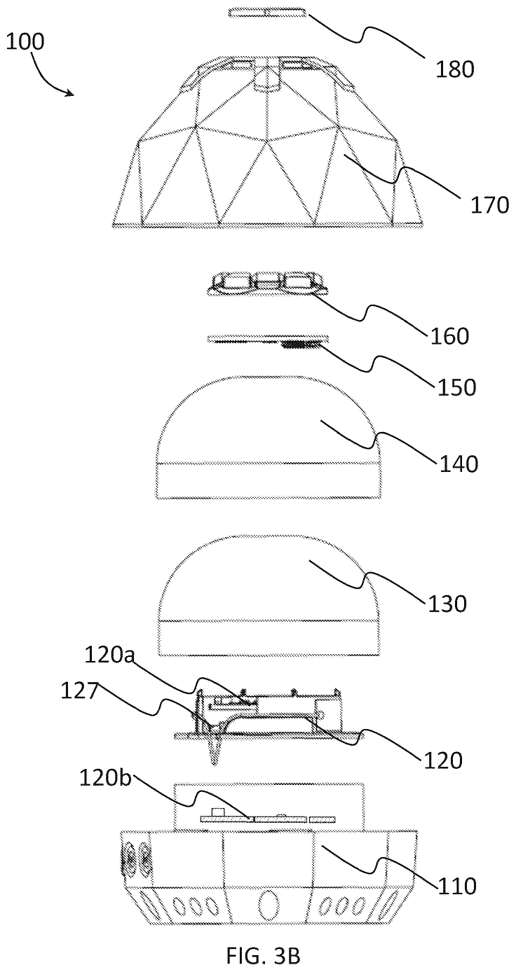

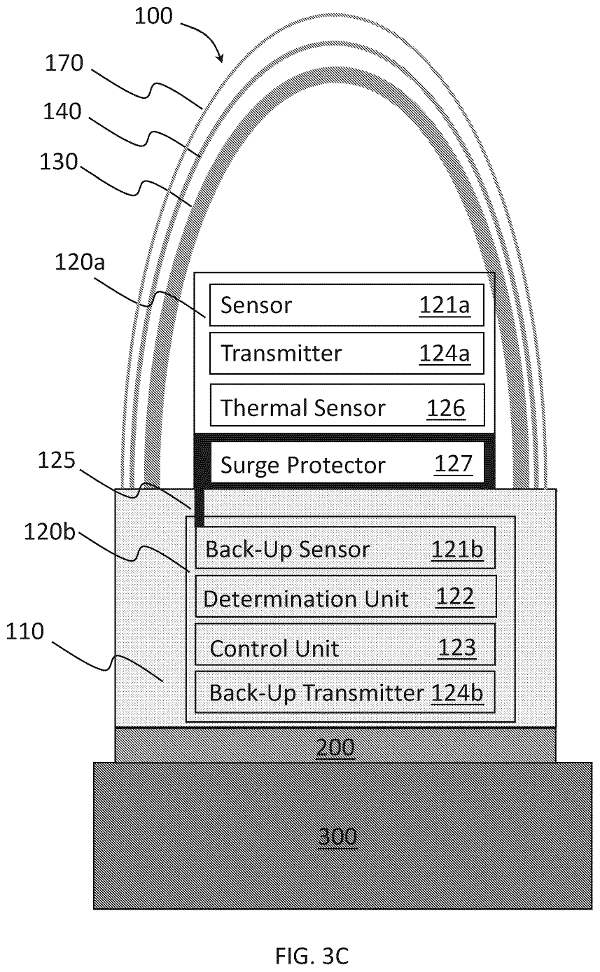

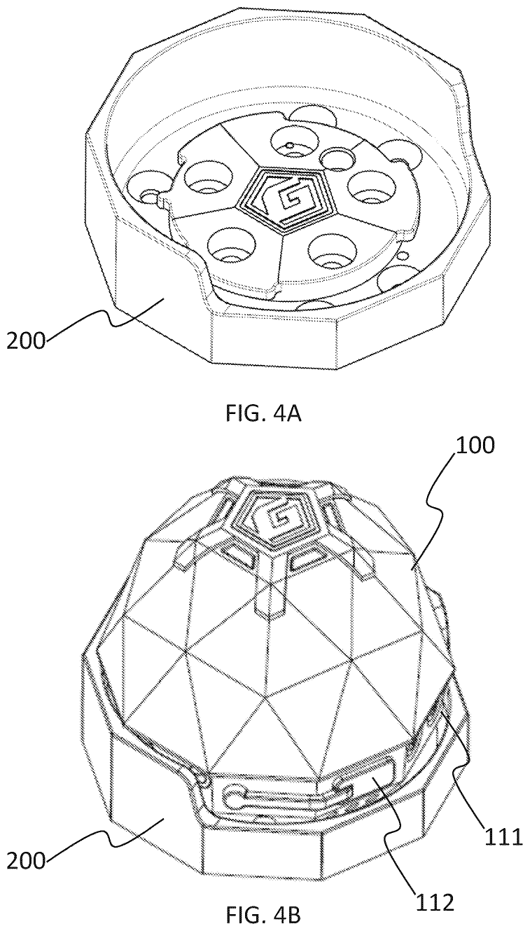

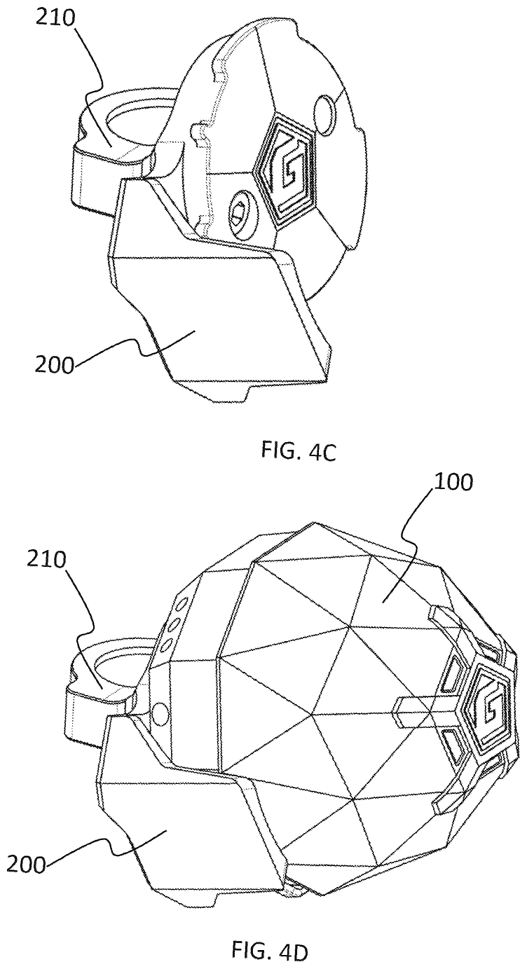

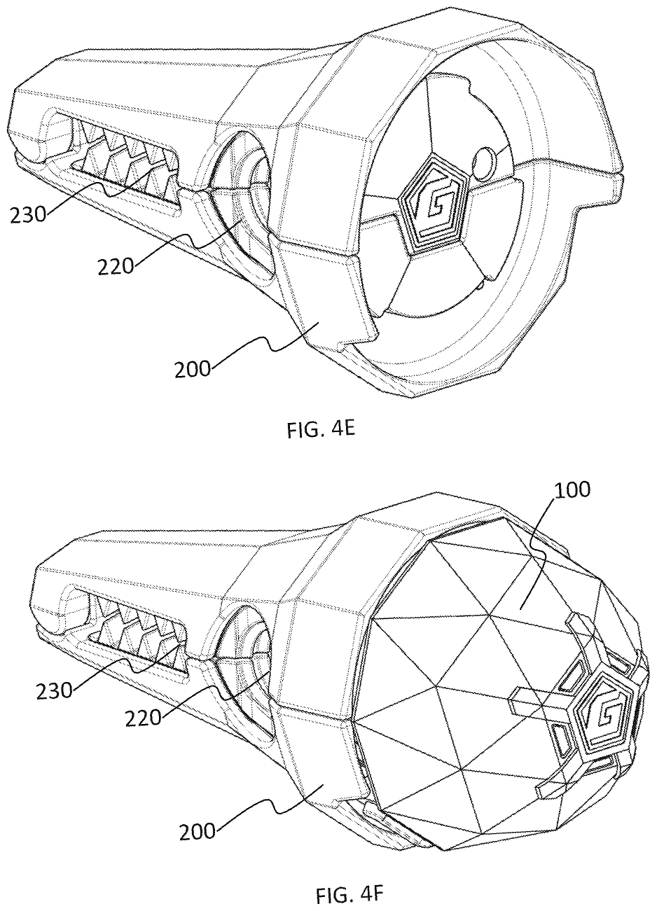

FIGS. 1, 2A-2C, and 3A-3C illustrate examples of a security device 100, with FIGS. 2A-2C showing a first example and FIG. 3A-3C showing a second example. FIG. 1 provides a top view of the security device 100. FIGS. 2A & 3A provides cross sections of the security device 100, viewed from the side through the line A-A illustrated in FIG. 1. FIGS. 2B & 3B provide exploded views, illustrating how different layers of the security device 100 are assembled together. FIGS. 2C & 3C provide schematic illustrations of the security device 100 together with a mount 200.

During use, the security device 100 is mounted to the mount 200. The mount 200 is attached to an object 300 that is to be protected. An example of a mount 200 is a universal baseplate which is secured to the object 300 that is to be protected. The security device 100 monitors its own status, which is communicated to a mobile device 400 that is in the possession of the owner of the valuable object 300. The status of the security device 100 can be used to infer the status of the object 300 because during use, the security device 100 is secured to the object 300 via the mount 200. If a breach of security is detected by the security device 100, this may indicate an attempt to attack of the object 300 or an attempt to attack the security device 100 itself.

FIG. 2 A illustrates that the security device 100 includes a lower housing 110, an inner housing 120, a cover 130, a layer of fibres 140, a printed circuit board (PCB) 150, a light tube 160, an outer housing 170, and a badge 180. FIG. 2B shows how these parts are assembled together.

The security device 100 further includes electronic components 121-124 which are held in place by the inner housing 120, and enclosed by a housing which is configured to restrict access to these electronic components 121-124. This housing is formed from the lower housing 110, the cover 130, the layer of fibres 140, and the outer housing 170.

The lower housing serves as a base 110 for attaching the security device 100 to the mount 200 which is attached to the object 300. The lower housing further serves as a bunker 110 for protecting some of the electronic components of the security device 100.

FIG. 2C depicts how the housing is configured to allow transmission of communication signals between the security device 100 and other devices (400, 500, 600). This allows the security device 100 to communicate directly with the mobile device 400 using short-range communication, to communicate indirectly with the mobile device 400 using long-range communication via a mobile network 500, and to receive global positioning information from a satellite 600. Instead, or in addition, the security device, when under attack, may be able to communicate with drones or auto-tracking camera systems in order to survey the thief, record their actions and stream the footage to a backend server on the network, with the evidence ultimately being sent to the user.

The bunker 110 in FIG. 2C may enclose the determination unit 122 and the control unit 123, to provide these electrical components with additional protection. Alternatively, the determination unit 122 and the control unit 123 may be located on top of the base 110, rather than being secured in a bunker 110. FIGS. 3A-3C show an example for which the determination unit 122 and the control unit 123 are located in the base 110.

The transmission of communication signals is facilitated by the housing being transparent to radio waves. This allows communication signals to be conveyed between the security device and external devices. In particular, the cover 130, the layer of fibres 140 and the outer housing 170 are all transparent to radio waves. The cover 130 is referred to as a ‘cup’, because it serves to store internal components while protecting them from the external environment. The layer of fibres 140 is referred to as a ‘sock’, because it is shaped to fit over the cover 130, adding a further layer of protection to the internal components that are stored inside.

The cover 130 is formed from composite material, which is transparent to radio waves. The cover 130 may be formed by pressing together a number of layers of material in the presence of an adhesive which holds in place these layers of material. A possible way to manufacture the cover 130 is using a hydraulic press, although a number of other techniques are envisaged such as moulding. Thus, the cover 130 can be formed by inserting the layers of material into a press or a mould together with an adhesive, allowing the adhesive to set the layers of material into the selected shape, and then removing the composite part from the press or mould.

The layers of the cover 130 are formed from a material that is selected to confer strength, with an adhesive being selected that allows the cover 130 to maintain a rigid shape. In addition to the material being selected to confer strength to the cover 130, the cover 130 is shaped to resist external stress forces. Thus, the cover 130 has a dome shape to distribute any external force evenly over the entire dome, reducing load at any specific point. This serves to protect electronic components 121-124 that are stored within it. The cover 130 may be formed from a press-moulded aramid and a polymer composite, which is strong enough to withstand an impact force from a tool such as a hammer. Other materials which could be used to manufacture the cover 130, which also possess properties of high-tensile strength, toughness, impact resistance and radio transparency, may include, but are not limited to, any variant of fiberglass, carbon fibre and ceramics.

In some cases, these materials may be combined as a composite or layered with other such materials. It is also possible to have multiple shells—for example, a pressed aramid shell with a separate fiberglass shell on top or underneath. These shells may also be joined together, via an adhesive for example, acting as one, but with clearly distinct parts. Thus, disclosure is provided of a cover 130 that is formed from a plurality of shells, each shell having a selected strength profile. This can be achieved, for example, by the shells being formed from different materials, or the layers being arranged so that strength is conferred along specific directions. As a consequence, the different strength profiles contribute in synergy to provide a cover 130 that can withstand impact forces, while also being sufficiently transparent as to permit the transmission of radio signals from the antenna. The adhesive used in the pressed fibre shell has a low dielectric constant. This is so the radio transmission is as strong as possible. This then means the device works more effectively and can communicate an alert quicker and more reliably. Variants of epoxy resin are found to work effectively at transmitting radio signals. Variants of phenolic resin are suitable, although work less effectively at transmitting radio signals. An adhesive is selected having a dielectric constant that is low enough to ensure a reliable transmission of a radio signal. The dielectric constant is defined as a material's ability to store charge when used as a capacitor dielectric. Preferably, an adhesive is selected having a dielectric constant that is as low as possible. For example, an adhesive is selected having a dielectric constant that is less than or equal to 6.0 when exposed to a radio wave having a frequency in the range 1 kHz to 1 MHz.

Protecting the electronic components 121-124 from the impact force prevents damage to the security device 100, allowing any attempted theft to be detected and reported before the electronic components 121-124 have been compromised.

Composite materials allow the strength profile of the cover 130 to be selected, while also being light in weight. This enables the electronic components 121-124 to be protected from an attack, while also enabling an alarm signal to be transmitted to the owner. The use of composite materials is preferable to metal, which would provide strength although would not allow radio signals to pass though.

For the example illustrated of the security device 100, the protection of the electronic components 121-124 is further enhanced by reducing their vulnerability to attempts to drill through the housing. This is achieved by the housing including a layer of fibres 140. The layer of fibres includes fibres that are arranged loosely enough for each of the fibres to move relative to one another. As a consequence, the fibres are arranged loosely enough so that if an attempt is made to drill through the housing, then the fibres will become wrapped around the drill-bit, preventing the drill-bit from turning. Arranging the fibres loosely causes the drill-bit to become jammed up if an attempt is made to drill through the housing.

The layer of fibres 140 may form a piece of fabric, for example being manufactured by weaving, knitting, or stitching. The layer of fibres 140 may be formed from a dry aramid fibre, because it provides individual fibres that have the strength to contribute to stopping a drill attack. Thus, disclosure is provided of a layer of loose aramid cloth 140, which sits on top of the cup to resist a drill attack. The cover 130 and the layer of fibres 140 serve to prevent damage to the security device 100, or at least delay damage to internal components. This allowing the attempted theft to be detected and reported before the electronic components 121-124 have been compromised. This gives the owner time to respond to a report of an attack, with the aim of preventing theft of the valuable object 300. The layer of fibres 140 is held in place between the cover 130 and the outer housing 170. The layer of fibres 140 is shaped to fit over the cover 130, and occupy the space between the cover 130 and the outer housing 170. As a result, the cover 130 and the layer of fibres 140 work in synergy to protect the electronic components 121-124 from both a hammer attack and a drill attack.

The outer housing 170 is water and dust resistant, contributing a first line of defence to the weather as well as thieves. Thus, the outer housing 170 provides an attractive finish that contributes a deterrent to potential attackers, as well as protecting internal components of the security device 100 from weather.

The printed circuit board 150 includes a light source and a loud speaker, which both serve to indicate a security breach to anyone in close vicinity to the security device 100, thus drawing maximum attention in the event of an attempted theft. The light source 150 provides strobe lighting, which is guided by the light tube 160, to provide a visual deterrent that indicates that there has been a security breach. The visual deterrent is accompanied by a piercing 100 dB siren from the loud speaker. The light source 150 is configured to indicate the status of the security device 100, which in addition to identifying an unauthorised attempt to move the object, can also be used to illuminate the surroundings upon demand by the user.

For the case in which the object is a vehicle 300, the light source 150 can be used to illuminate the surroundings while the vehicle is in motion. Thus, the security device 100 is further configured to serve the purpose of a head lamp or rear lamp. Providing the additional functionality of lighting serves to reduce the overall weight of the vehicle, which is particularly valuable when using the security device 100 to protect a bicycle 300. The owner can provide instructions to the security device 100 using an application installed on their mobile device 400, thus allowing the owner to control the lamp by instructing the light source 150 to turn on or off. As an example, the light source 150 includes red light emitting diodes (LEDs), which serve as a rear bike light. The lighting mode can be selected to be flashing or constant. Upon reaching the destination, the owner can use the same software application to turn off the lights, and select an alert mode for the security device 100. Thus, a user-friendly approach is provided, simplifying way that security of the vehicle 300 is actuated.

The schematic in FIG. 2C illustrates that the inner housing 120 houses one or more sensor 121, a determination unit 122, a control unit 123, and one or more transmitter 124. During use, the one or more sensors 121 serve to sense a status of the security device 100, which is used to infer a status of the object 300. The status indicated by the security device can include an ‘alert’ mode while it is monitoring the environment for potential attacks, an ‘alarm’ mode if an attack trigger has indicated an unauthorised attempt to move the object 300, and an ‘authorised’ mode if the owner has indicated that movement of the object 300 is currently permitted.

The determination unit 122 is configured to determine the status of the security device 100, based on an output of the sensor 121, in order to detect any unauthorised attempt to move the object 300. Thus, a security device 100 is envisaged that has self-monitoring capabilities.

The control unit 123 is configured to issue an alarm signal in response to the determination unit 122 determining the status of the security device 100. Accordingly, if an alert trigger is identified then the status changes from ‘alert’ mode to ‘alarm’ mode, with the consequence that an alarm signal is issued.

The one or more transmitters 124 serve to transmit the alarm signal to a mobile device 400. The long-range antenna 124 transmits the alarm signal to the mobile device 400 via the network 500. Furthermore, if the mobile device 400 is in close enough range, it can also receive the alarm signal directly from the short-range antenna 124. Thus, the alert will typically be sent from the security device 100 to a backend platform 500 (e.g., hosted by a cloud server), with the backend platform 500 then sending the alert to the user's mobile device 400. The security device 100 may send the alert by communicating directly with the mobile device 400.

Disclosure is provided of the security device being arranged to exchange data with external devices. To achieve this, the inner housing 120 is installed with an antenna (121, 124) and a processor (122, 123), as illustrated by the cross section view in FIG. 2A.

It will be understood that an apparatus feature can perform multiple functions, such as the security device shown in FIG. 2A including an antenna that serves the functionality of both the sensor 121 and the transmitter 124, as well as the processor serving the functionality of both the determination unit 122 and the control unit 123. Furthermore, a number of sensors 121 and a number of transmitters 124 can be provided, each of which is specialised to contribute enhanced functionality. The sensors 121 are used simultaneously, to issue an attack trigger as soon as at least one of the sensors 121 detects movement of the security device 100. A number of different types of antennas (121, 124) and sensors 121 are envisaged, including:
A short-range antenna 121 which is configured to communicate directly with the mobile device 400 using short-range signals (e.g., Bluetooth (registered trade mark)). The short-range antenna may serve as both a sensor 121 and a transmitter 124. The short-range antenna is configured to exchange data between the security device 100 and the mobile device 400, with the control unit 123 being configured to execute an instruction received from the mobile device 400 by the short-range antenna 121. For example, the short-range antenna 121 can be used to unlock a locking mechanism between the security device 100 and the mount. Furthermore, the short-range antenna 121 can be used to turn on the light source 150 of the security device 100.
A long-range antenna 121 which is configured to communicate indirectly with the mobile device 400 via a network 500, using long-range signals (e.g., LTE (Long-Term Evolution wireless broadband) (registered trade mark)). The long-range antenna may serve as both a sensor 121 and a transmitter 124. This allows an alarm signal to be relayed to the mobile device 400, from the security device 100 via a network 500 (e.g., a broadband cellular network). Accordingly, if there is a breach of security, the user is notified that the status of the security device 100 has changed from ‘alert’ mode to ‘alarm’ mode. An application installed on the mobile device 400 interprets an alarm signal received from the security device 100, and provides an instant alert to the user, serving as a prompt that a security breach has been detected.
A geolocation antenna 121 which is configured to receive a radio signal from a global navigation satellite system (GNSS) 600 (e.g., a satellite of the Global Positioning System (GPS)). Thus, the geolocation antenna may serve as a sensor 121. For this arrangement, the determination unit 122 is configured to identify, from the radio signal received from the global navigation satellite 600, whether the security device 100 has been moved. A geofence establishes a virtual perimeter within which the valuable object 300 is to be confined unless it is authorised to be moved by the owner. This is achieved by the determination unit determining whether a change in a position of the security device 100 is greater than a threshold amount. The control unit 123 is configured to issue the alarm signal in response to the determination unit 122 determining that change in the position of the security device 100 is greater than the threshold amount. In the event of an attempted theft, the geofence setting will use the radio signal from the GNSS to monitor the position of the security device 100, so that the current position of the security device 100 is reported to the user, facilitating recovery of the object 300.
An accelerometer 121 which may serve as a motion sensor. The accelerometer 121 has a level of sensitivity that is selected in order to detect any impact forces. This allows a hammer attack or a drill attack to be identified in time for an alarm signal to be transmitted. For this arrangement, the determination unit 122 is configured to determine the status of the security device 100 based on the impact force being above a threshold value. If an attempt is made to damage the electronic components 121-124, then the alarm signal is notified to the mobile device 400 before any breach is made of the housing that protects them.
A camera 121 which may monitor the environment of the security device 100. The determination unit 122 may be configured to analyse the images, in order to detect an attempt to steal the object 300. Images from the camera 121 can be transmitted by the transmitter 124 to the mobile device 400, with the software application allowing these images to be displayed to the user. Furthermore, the software application allows the user to provide instructions to control the camera 121, which are communicated via the network 500 to the security device 100. Instructions received by an antenna 121 of the security device are implemented by the control unit 123, allowing the user to control operation of the security device 100. Images received from the camera 121 of the security device 100 can be stored in a memory of the mobile device 400, which can serve as evidence of a security breach. The integrated camera 121 may be positioned anywhere outside of the lower housing 110 (bunker), or if positioned inside the lower housing 110 would be poking through a wall of the lower housing 110.
A thermal sensor 126 which may monitor the temperature of the security device. A thermal sensor 126 may be provided as part of the circuit board (120; 120a). The thermal sensor 126 serves to initiate an alert to the owner in the event of a thermal attack—for example, a thief trying to burn the security device 100. If the internal temperature of the device rises above a threshold value, the security device 100 initiates an alert and the alarm will trigger.

Note that it is not essential for the security device 100 to include all of the above electrical components. The security device 100 includes one or more sensor 121, although may not include all of the above sensors. For example, the cost of the security device 100 can be reduced by not including an integrated camera.

The determination unit 122 is configured to detect an attack trigger, which identifies an unauthorised attempt to move the object 300. If this happens, then the control unit 123 implements an ‘alarm’ mode, in which case an audible alarm will sound, the lights 150 will illuminate to provide a visual alert, and the user will be notified. The owner of the valuable object 300 is notified, for example, using the long-range antenna 124 (e.g., via short messaging service (SMS)) and/or using the short-range antenna 124 (e.g., via Bluetooth (registered trade mark)). The owner of the valuable object 300 is typically notified using the long-range antenna 124, as they would likely be outside of the range for being contacted directly by the short-range antenna.

FIG. 2A illustrates an inner housing 120 which sits on the lower housing 110. The lower housing 110 includes a raised cylindrical section, on top of which the inner housing 120 is fixed in place. The dome-shaped cover 130 sits over the inner housing 120, being installed by sliding it down the sides of the cylindrical protrusion of the lower housing 110. The cover 130 is glued into place, to provide a strong bond between the cover and the lower housing 110. The layer of fibres 140 is then placed on top of the cover 130, which is held in place by the outer housing 170.

The inner housing 120 is a plastic part which comprises a circuit board 120 which contains the short-range antenna (e.g., Bluetooth antenna (Bluetooth is a registered trade mark)), the geolocation antenna (e.g., GNSS antenna, GPS antenna), and the long-range antenna (e.g., LTE antenna). To prevent interference, these antennas 121 may be arranged separated from one another, such as the short-range antenna and geolocation antenna being arranged on one side of the circuit board 120, and the long-range antenna being arranged on the other side of the circuit board 120. Furthermore, keeping the antennas separated from one another makes it difficult for them to be disabled simultaneously, enhancing the robustness of the security device 100 to attack. If a thief could disable the antennas 121 quickly, before an alert was transmitted to the owner, all the technology (and cost to purchase such a technologically advanced device) becomes academic. Thus, the housing (130, 140) is arranged to protect the antennas (121, 124) from hammer attacks and/or drill attacks. In FIG. 2A, the inner housing 120 is shown comprising the electronic components 121-124, including the sensor 121, the determination unit 122, the control unit 123, and the transmitter 124. Arranging one or more antenna (121, 124) on top of the lower housing 110 ensures that radio signals can be transmitted and received.

FIGS. 3A-3C provides disclosure of an alternative arrangement of a security device 100, with features that correspond to FIGS. 1, 2A-2C being illustrated by corresponding reference numerals. FIGS. 3A-3C discloses an arrangement for which one or more antenna (121a, 124a) continues to be housed by an inner housing 120 of the type described for FIGS. 2A-2C. Other electronic components (121b, 122, 123, 124b) are enclosed by the lower housing 110. For this alternative arrangement, the lower housing 110 serves as an enclosure 110 that protects these electronic components. For example, the lower housing 110 protects the determination unit 122 and the control unit 123. The security device 100 includes a first circuit board 120a which is installed with one or more main antenna (121a, 124a), and a second circuit board 120b which is installed with one or more backup antenna (121b, 124b) as well as the determination unit 122 and the control unit 123. The second circuit board 120b is referred to as the main circuit board 120b, because it contains the control unit 123 which controls the operation of the security device 100. FIG. 3B shows the security device 100 arranged having a top circuit board 160 which includes the light source, a middle circuit board 120a including the main antenna, and a lower circuit board 120b including the backup antenna as well as the control electronics.

The first circuit board 120a is connected to the second circuit board 120b by a wire 125 which passes through a hole in the lower housing 110. Electronic components that are protected by the lower housing 110 may also include the locking mechanism which is used to provide a releasable connection between the security device 100 and the mount 200.

The security device 100 further includes a power surge protector 127. The power surge protector 127 may comprise a power surge protection circuit board. FIG. 3A shows a power surge protection circuit board which sits on top on the bunker 110, underneath the middle board 120a, being attached to the middle board 120a via soldered stands, and secured to the inner housing 120.

The purpose of the power surge protection board 127 is to prevent a hostile attack on the security device 100 via a large power surge from destroying core electronics of the security device 100. The power surge protector 127 does this by preventing an electrical supply above safe levels of current, voltage, or power from entering the circuitry of the security device. If a power surge is significant enough, the power surge protector circuit board 127 will be blown, acting in a sacrificial manor to protect key circuitry of the security device 100. So, in the event of an attack, this enables the security device 100 to still operate effectively, both mechanically and with its electronics. The power surge protector 127 may also be configured to mitigate a power surge attack that is targeted at magnetic contacts of the output port 111.

Any current that is input will initially flow from the USBC port to this board. If the power input is at a safe level, below a threshold, the power will be allowed to flow to the rest of the circuitry of the security device 100. If the power surge is significant enough, above the threshold, the power surge protection circuit board 127 will not allow the power to flow to the rest of the circuitry. So, in the event of an attack of this nature, this enables the security device 100 to still operate effectively, both mechanically and with its electronics intact and operational.

The power will initially flow from the USBC port to the power protection board 127. Then if the power is below the safe threshold values of current, voltage and power, then the electrical power flows from the power protection board 127 to the middle board 120a, then from the middle board to the main board 120b in the bunker 110. The position of the power protection board 127, above the bunker 110 and away from the main board 120b, is significant in order to prevent any large power inputs from arcing between these boards (127, 120b) and damaging the core circuitry.

For the security device shown in FIG. 3C, the lower housing 110 serves as an enclosure which is strong enough to protect electronic components (121b, 122, 123, 124b) of the security device 100. The lower housing is hardened, making it harder to compromise and confers resistance to cutting, drilling, breakage and removal. To confer strength above a threshold value, the enclosure 110 may comprise steel. The enclosure 110 is configured to withstand an attack with any force that can reasonably be applied/executed by a human wielding/using handheld tools which aren't powered by any force other than that coming from the assailant. The enclosure 110 has a strength profile that in the event of a drill-attack, a power drill will either be completely stopped, or significantly slowed up, depending on the drill bit that is used—any standard drill bit will not penetrate the enclosure 110—only highly specialist drill bits can drill through the enclosure 110. Without specialist equipment, it isn't expected that a human would be able to break this part using tools and human applied/generated forces. Electronics components enclosed by the enclosure 110 include the determination unit 122 and the control unit 123, which may be provided on a circuit board 120b which is protected by the enclosure 110. The enclosure 110 may further contain a backup antenna (121b, 124b), with the backup antenna including a sensor 121b and a transmitter 124b. The backup antenna (121b, 124b) serves as a backup in the event that the main antenna (121, 124) is damaged.

The enclosure may be referred to as a bunker 110. The enclosure 110 is strong, although is formed from a material that inhibits the transmission of radio waves. Therefore, the main antenna (121a, 124a) is located outside of the enclosure 110, which enhances the range of transmission of the main antenna (121a, 124a). Locating the main antenna (121a, 124a) outside of the bunker 110 does leave it relatively exposed to attack, and so it is protected by a cover 130.

As explained for the example shown in FIGS. 2A-2C, the security device 100 may include a number of different types of antennas (121a, 121b, 124a, 124b) and sensors (121a, 121b). The main circuit board 120b may include one or more of a short-range antenna, a long-range antenna, a geolocation antenna, an accelerometer, a camera, and a thermal sensor 126, or any combination thereof. Similarly, the backup circuit board 120a may include one or more of a short-range antenna, a long-range antenna, a geolocation antenna, an accelerometer, a camera, and a thermal sensor 126, or any combination thereof.

The cover 130 comprises material that is transparent to radio waves that are transmitted by the main antenna (121a, 124a), and so the security device 100 can transmit long-range signals. The cover 130 may comprise composite material, such as aramid fibre together with an adhesive. The cover 130, for the arrangement shown in FIG. 3C, has corresponding attributes to the cover 130 that is shown in FIGS. 1, 2A-2C. In particular, the cover 130 may be shaped to resist external stress forces. For example, the cover 130 may be dome-shaped, which confers strength to the cover 130 by virtue of its shape allowing the dissipation of impact forces.

The cover 130, which typically is provided as an aramid cup, serves to protect the antennas outside of the attack bunker 110, so that they function effectively during an attack for long enough to transmit an alert to the owner, before being destroyed. Made from compressed layers of aramid fibres, the cover 130 benefits from radio-transmissible properties, which is advantageous for permitting the external antennas to operate.

The process by which the cover 130 is made ensures the cover 130 has the structural strength that is desired in order to resist an aggressive attack for long enough. A possible technique for manufacturing the cover 130 is as follows: 1) Start with the desired number of preform-shaped fibre sheets. These sheets are impregnated with a resin to bind the layers together later in the process. These shapes and the position they are placed into during the process ensures maximum strength of the finished part and resistance to external forces.

2) These shapes are then compressed in a mould at a constant temperature and pressure for a pre-set amount of time. Temperatures are in excess of 100 degrees centigrade, and pressures in the 100's of PSI (pounds per square inch) for several minutes at a time.

3) The mould itself uses hydraulics to achieve these extreme pressures, with male and female matched metal die sets.

The cover 130 is manufactured in a similar way to bulletproof helmets. This cover 130 may be manufactured with ceramic beads inserted and then pressed between the layers of aramid fibre. This is to add overall strength as well as drill-resistant properties. The sides of the aramid cup 130 slide down the side of the bunker 110. This is permanently glued in place and means there is no access to the antennas. Any attack will most likely be delayed long enough for the antennas to send an alert signal to the owner. The cup 130 is dome shaped for maximum external stress and impact resistance.

For this alternative arrangement, as is shown in FIG. 3C, a hole in the lower housing 110 allows wires 125 to provide an electronic connection between the main antenna (121a, 124a) and the other electronic components (122, 123). To protect these electronic components (122, 123), the lower housing 110 is formed from a tough material, such as toughened steel.

For the arrangement shown in FIG. 3C, the security device 100 includes a second circuit board 120a on the outside of the enclosure 110 which provides an electrical connection to the main antenna, and a main circuit board 120b on the inside of the enclosure 110 which provides an electrical connection to the backup antenna. The main circuit board 120b, which controls the operations on the device, sits underneath, and is entirely contained within, a steel structure—we call this the attack bunker 110. This is to protect the main circuit board 120b, even in the event of a determined and sustained attack.

This main board 120b also contains a secondary Bluetooth antenna which enables the user to control the device via Bluetooth at short-range in the event that the main Bluetooth antenna, and LTE/GPS antennas, all sitting outside the bunker, are destroyed. The main Bluetooth antenna, LTE antenna, and GPS antenna sit on top on the attack bunker, (note that Bluetooth is a registered trade mark). This communication is possible through radio waves propagating out of a small oval shaped hole in the bunker 110 which is 8 mm long and 4 mm wide.

The main Bluetooth antenna is part of a secondary circuit board 120a sitting within our plastic inner housing 170. This inner housing 170 sits on top of the attack bunker 110. It is expected that this main Bluetooth antenna (121a, 124b) will be used by the user for the vast majority of the time, as it will benefit from both a stronger signal and longer-range signal, relative to the Bluetooth antenna (121b, 124b) sitting within the bunker 110. The Bluetooth antenna in the bunker 110 is to enable the user to control the device 100 when the other antennas (121a, 124a) are destroyed. The LTE antenna and GPS antenna are mounted to the plastic inner housing, which sits on the attack bunker 110. These main antennas (121a, 124a) are positioned outside of the steel attack bunker 110 as positioning them inside the bunker 110 would render them ineffective, as radio waves won't travel through the steel, and the backup antennas (121b, 124b) are restricted to transmitting short-range signals out of the small oval hole in the attack bunker 110. Thus, the backup antenna serves to allow control of the device in the event that the main antennas are compromised.

The LTE and GPS antennas (121a, 124a) are wired into the main board 120b, with cables 125 coming up through the oval hole in the bunker 110. The secondary circuit board 120a, containing the main Bluetooth antenna (121a, 124a), is also wired to the main board 120b, with a cable 125 coming up through the oval hole, (note that Bluetooth is a registered trade mark).

If there was no attack bunker 110 present, all antennas (notably the secondary Bluetooth antenna (121b, 124b)) would be exposed by being positioned where they could be attacked and destroyed—this is a particular issue if once the security device 100 has been locked to the attachment the user cannot use/operate the valuable item they are securing.

The mount 200 may act as an immobiliser or lock once the security device 100 is secured in place with its attachment. If the user cannot remove the security device 100, then they cannot use the valuable item 300. For example, the throttle lock attachment (FIGS. 4E-4F) immobilises the throttle and brake lever of a motorcycle. If an attacker was able to destroy all antennas, the user cannot then communicate with the device 100 and remove it. The attack bunker 110, which contains the main circuit board 120b, effectively the brain of the device 100, along with the secondary Bluetooth antenna, will enable the user to remove the security device 100, communicating with the secondary Bluetooth antenna, even after a determined attack where catastrophic damage was caused to the LTE antenna, GPS antenna and main Bluetooth antenna, (note that Bluetooth is a registered trade mark).

The lower housing 110 is formed from a material that doesn't transmit radio signals, and so the antennas (121, 124) are arranged outside of the enclosure, with protection being provided as shown in FIG. 2C by the cover (130, 140). If the security device 100 is attacked, it is possible that the one or more sensor 121 and the one or more transmitter 124 may be damaged. As a consequence, an attack on the security device 100 can result in all of the antennas (121, 124) being disabled. There is a demand for a way to communicate with the security device 100 even after the disabling of all of the antennas (121, 124) that are located in the inner housing 120.

The lower housing 110 is likely to remain intact following an attack on the security device 100, due to the lower housing 110 being formed from a strong material. This ensures that features such as the locking mechanism can continue to function after the attack, so that the security device 100 continues to be locked to the mount 200. If the owner regains possession of the object 300 following an attack, they will be motivated to unlock the security device 100 from the mount 200. Disclosure is provided of a short-range antenna being installed in the lower housing 110, which allows communication with the mobile device 400 via the hole through which the cables pass from the lower housing 110 to the inner housing 120.

Thus, a security device 100 is envisaged that includes a first antenna and a second antenna, as illustrated by FIGS. 3A-3C. The first antenna is installed in the inner housing 120, as explained above with respect to FIGS. 2A-2C. The first antenna may be a short-range antenna that can communicate with the mobile device 400, for example, via Bluetooth (registered trade mark) with a range of around 50 metres. The second antenna is a short-range antenna that is installed in the enclosure provided by the lower housing 110. Since the second antenna is surrounded by a material which doesn't transmit radio waves, the only way for communication to be achieved with the mobile device 400 is via the hole through which the wires connect with the antennas (121, 124). Due to the second antenna communicating via a small hole, this restricts the range of communication with the mobile device 400. The second short-range antenna can communicate with the mobile device 400, for example, via Bluetooth (registered trade mark) in some cases, more than 1 metre range maybe possible. In fact, depending on the condition of the security device 100 following the attack, it's possible that the mobile device 400 will only be in range if placed in close proximity to the hole of the lower housing 110. The second antenna serves as a backup to the first antenna. As a result, in the event of the first antenna (121, 124) being destroyed, then it continues to be possible for the security device 100 to be controlled by the mobile device 400 using the second antenna. Thus, the owner is able to unlock the security device 100 from the mount 200.

The hole in the enclosure 110 does contribute a vulnerability, through which the backup antenna (121b, 124b) could be attacked. This vulnerability can be mitigated by filling the enclosure 110 with a filler material (e.g., a potting compound), which prevents access to the electronic components (121b, 122, 123, 124b) via this hole in the enclosure 110. This filler material has a low dielectric constant, in order to allow the backup antenna to transmit radio waves out of the hole. The backup antenna is a low range antenna, such as a Bluetooth antenna (note that Bluetooth is a registered trade mark).

A further function of the attack bunker 110 is to prevent a potential thief from easily accessing the locking pin. It is the locking pin, that once extended from security device 100 into the attachment 200, prevents the device from being twisted anticlockwise and removed. So, if the attacker managed to forcibly remove the outer housing 170 and the aramid cup 130, they'd be met with the steel attack bunker 110 with no clear access to the locking pin. Only by physically pulling the locking pin out of the attachment 200 can the security device 100 be twisted anticlockwise and removed.

Three locking wings on the lower housing 110 of the security device 100 twist clockwise underneath locking wings on all attachments 200. This is what prevents lateral removal. Retracting the pin and twisting the security device 100 anticlockwise is the only way to remove the security device 100. To make it even harder to access and compromise the locking pin, the electronics within the bunker 110 are potted in a resin compound with ceramic beads. In effect, the small oval hole will provide no access.

The electronics may be set in a potting compound which may include ceramic beads. The potting compound serves as a filler material which prevents access to the electronic components. The potting compound has a low dielectric constant which enables the Bluetooth antenna (registered trade mark) to transmit radio frequencies through the compound. The beads are typically made of ceramic, may be of various sizes, and are integrated withing the potting compound to either stop drill bits, or make drilling incredibly difficult.

In addition to the above, a protector plate will be positioned alongside the locking pin, held in place once the potting compound has set. This is a steel plate which means that even if someone managed to drill out some potting compound with ceramic beads in, any instrument or tool of attack put in the oval hole would not be able to make direct contact with the locking pin, or at the very least make it incredibly difficult.

The security device 100 may further include a piezo alarm configured to act as a deterrent and drawing maximum attention in the event of a theft. In order to protect the piezo alarm, there is a steel piezo cover over the piezo hole. This, along with the steel sleeves of the attachments, makes access to the piezo difficult or impossible. Therefore, an attacker will find it hard or impossible to disarm the piezo.

FIGS. 4A-4F illustrate examples of bespoke mounts 200 that are configured to be mounted with the security device 100, and further configured to be secured to the object 300. The mount 200 is attached to the object 300, so that when the object 300 is to be protected, the security device 100 is installed in the security device. The security device 100 together with one or more of these mounts 200 forms a kit of parts, which during use serve in synergy to provide a security system. The mounts 200 are bespoke to the type of object 300 that is to be protected by the security device 100. The mount 200 is typically formed from weapons-grade hardened steel, which is protected by a layer of black powder coat and cathode electro deposition (CED) coating.

FIG. 4A shows a mount, with FIG. 4B showing the security device 100 installed in this mount 200. The mount can serve as a base plate 200, which is attached to the object 300 for example by bolting, screwing or gluing it into place. A locking mechanism of the security device 100 is configured to be received by the mount 200 to provide a releasable connection between the security device 100 and the mount 200. The security device 100 and the mount 200 are configured to be connected together by the locking mechanism, by bringing a surface of the security device 100 into contact with a corresponding surface of the mount 200, and then rotating the security device 100 relative to the mount 200. The locking mechanism is configured to release the security device 100 from the mount 200, if the security device 100 receives an instruction from the mobile device 400. A software application installed on the mobile device 400 is used by the owner to issue instructions to the security device 100, including arming and disarming the alarm function of the security device 100, as well as controlling the locking mechanism. FIG. 4C shows a mount 200 that includes a clamp 210, with FIG. 4D showing the security device 100 installed in this mount 200. The clamp 210 is configured to secure the security device 100 to a part of the vehicle 300. The clamp 210 may be configured to be wrapped around a tubular frame of the vehicle 300. For example, the clamp corresponds to a bike seat clamp 210 which is configured to hold the bicycle seat in place on the bicycle frame. The seat clamp 210 simply replaces the user's bicycle seat clamp, and allows the security device 100 to also serve as a rear bike light, with the light source including red light emitting diodes (LEDs) 150.

FIG. 4E shows a mount 200 that includes one or more lock (220, 230), with FIG. 4F showing the security device 100 installed in this mount 200. Each lock (220, 230) is configured to restrict movement of a component of a vehicle 300. In the example shown, the mount includes a throttle lock 220 and a brake lock 230. During use, the throttle lock 220 immobilises a throttle of the vehicle 300 and the brake lock 230 immobilises a brake lever of the vehicle. The brake lever can be set in both ‘on’, and ‘off positions. A configuration is envisaged in which the mount 200 includes both a clamp which secures the security device 100 to a part of the vehicle and a lock which restricts movement of a component of the vehicle 300.

All of the mounts 200 shown in FIGS. 4A-4F have a universal mating surface which will interface with the security device 100 in the same way. Hardened steel locking wings underneath the security device 100 will lock under corresponding hardened steel locking wings on the mount 200 by pushing the security device 100 on to the mount 200 and twisting the security device 100 clockwise. A hardened steel ‘attack bunker’ protects the internal locking mechanism from attack, preventing the security device 100 from being removed from the mount 200 unless this has been authorised. When the security device 100 is in the correct position, controlled by a stop pin preventing over-rotation, the user can use their app (and the Bluetooth connection (Bluetooth is a registered trade mark)) to drive a hardened steel locking pin of the security device 100 into the mount 200, thus preventing the security device 100 from being able to be twisted anti-clockwise and removed. Security is enhanced by a motor driven locking mechanism which controls the operation of the hardened steel locking pin of the security device 100. An instruction from the user can be used to actuate autonomous arming of the security device 100.

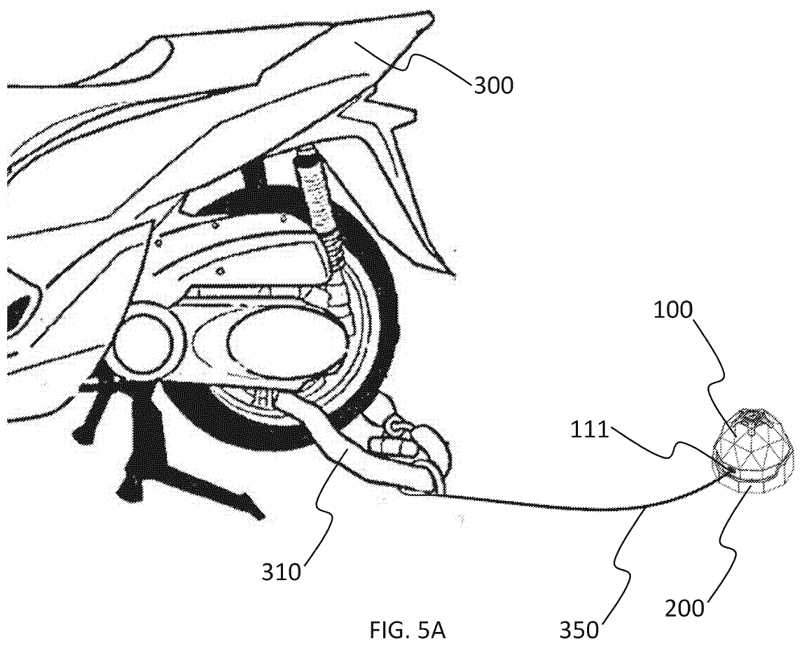

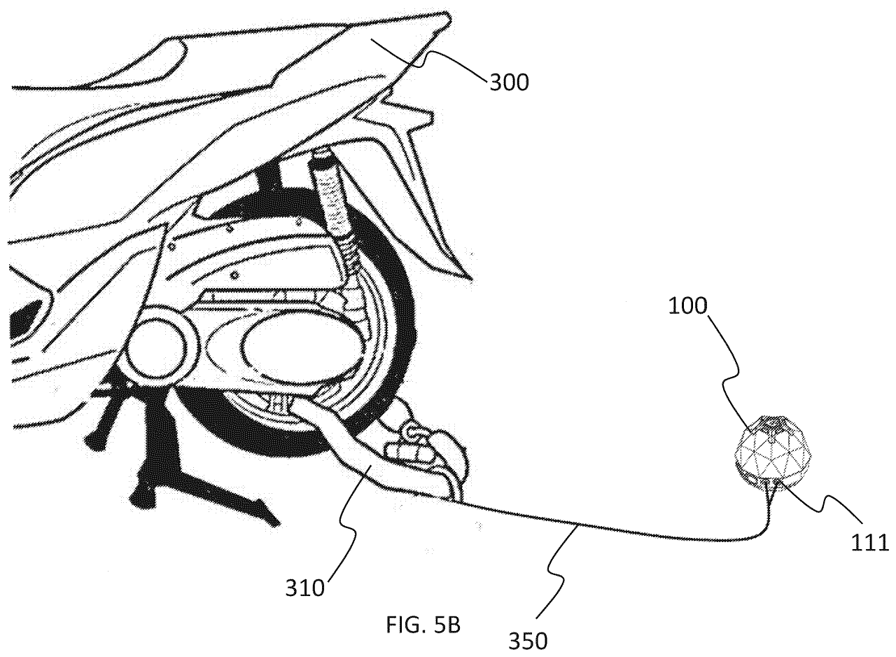

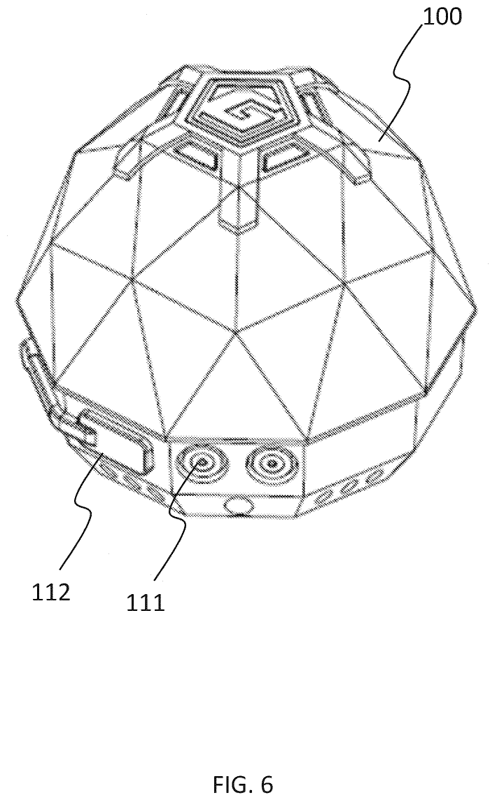

For the example of the motorbike throttle lock shown in FIGS. 4E-4F, with the security device 100 being in situ, and locked to the mount 200, the security device 100 will also lock/immobilise the object 300, as well as serving as an alarm and visual deterrent. Other mounts 200 are envisaged which can be combined with the security device 100 to provide for physical locking and immobilising valuables, as well providing smart tech security features. FIGS. 5A-5B illustrates the security device 100 arranged to monitor an electrical wire 350 that is secured to the object 300 via a chain 310 which locks the object in place. A motorbike 300 is shown with its rear wheel locked to a chain 310 which is monitored using the wire 350. In this example, the sensor 121 is configured to detect an electrical current that flows through the wire 350, and the determination unit 122 is configured to determine the status of the security device 100 based on a change in the electrical current that is detected by this sensor 121.

The security device includes an input port 111 which is configured to receive the electrical current that flows through the wire 350. The input port 111 may be further configured to receive electrical power to charge a battery of the security device 100. The input port may be a USB port 111 (e.g., USB Type-C (registered trade mark)), serving as both a data port and a charging port.

FIG. 4B shows an arrangement for which the input port 111 and the power connector are separate from one another. FIG. 4B shows that the security device 100 includes a cover 112 which protects the USB power connector when it is not in use.

A smart chain feature is envisaged that provides the chain 310 and the wire 350 in combination. This can be achieved by the smart chain having an electrical current running through the chain 310 itself in a complete loop, or having an electrical current running through a cable 350 which runs through the chain 310 and forms a complete loop. The security device 100 monitors an electrical signal from wire 350, thus indicating any attempt to move the chain 310. If the electrical current running through the chain 310 itself, or the electrical current running through the cable 350 (which runs through the chain 310), is compromised, then the security device 100 will monitor this and initiate an alarm to alert the owner. Thus, the security device 100 serves as a monitoring and broadcasting platform. It is possible for multiple chains 310 to be monitored at the same time.

While the present invention has been described with reference to embodiments, it is to be understood that the present invention is not limited to the disclosed embodiments. The present invention can be implemented in various forms without departing from the principal features of the present invention. The scope of the following claims is to be accorded the broadest interpretation so as to encompass all such modifications and equivalent structures and functions. Clauses

The following clauses form part of the description, and correspond to the claims of the priority application GB2218652.2.

1 A. A security device (100) configured to be secured to an object (300), the security device (100) comprising: a sensor (121) configured to sense a status of the security device (100); a determination unit (122) configured to determine the status of the security device (100), based on an output of the sensor (121); a control unit (123) configured to issue an alarm signal in response to the determination unit (122) determining the status of the security device (100); a transmitter (124) configured to transmit the alarm signal to a mobile device (400); and a housing (110, 120, 130, 140) configured to restrict access to the transmitter (121) and further configured to allow transmission of the alarm signal through the housing (130, 140), wherein the housing comprises a cover (130) formed by pressing together a number of layers of material and an adhesive.

2A. The security device (100) according to clause 1 A, wherein: the housing (130, 140) further comprises a layer of fibres (140) including fibres that are arranged loosely enough for each of the fibres to move relative to one another.

3 A. The security device (100) according to clause 1 A or clause 2A, wherein: the sensor (121) is configured to monitor an electrical current that flows through a wire (350) that is configured to be secured to the object (300); and the determination unit (122) is configured to determine the status of the security device (100) based on a change in the electrical current that is monitored by the sensor (121).

4A. The security device (100) according to clause 3A, further comprising: an input port (111) configured to receive the electrical current that flows through the wire (350) that is configured to be secured to the object (300).

5 A. The security device (100) according to clause 4A, wherein: the input port (111) is further configured to receive electrical power to charge a battery of the security device (100).

6A. The security device (100) according to any preceding clause, wherein: the sensor comprises a long-range antenna (121) configured to communicate indirectly with the mobile device (400) via a network (500).

7A. The security device (100) according to any preceding clause, wherein: the sensor comprises a short-range antenna (121) configured to communicate directly with the mobile device (400).

8A. The security device (100) according to clause 7A, wherein: the short-range antenna (121) is configured to exchange data between the security device (100) and the mobile device (400); and the control unit (123) is configured to execute an instruction received from the mobile device (400) by the short-range antenna (121). 9A. The security device (100) according to any preceding clause, wherein: the sensor (121) is configured to receive a radio signal from a global navigation satellite (600); the determination unit (122) is configured to identify, from the radio signal, whether a change in a position of the security device (100) is greater than a threshold amount; and the control unit (123) is configured to issue the alarm signal in response to the determination unit (122) determining that change in the position of the security device (100) is greater than the threshold amount.

10A. The security device (100) according to any preceding clause, wherein: the sensor comprises an accelerometer (121) configured to detect an impact force; and the determination unit (122) is configured to determine the status of the security device (100) based on the impact force being above a threshold value.

11 A. The security device (100) according to any preceding clause, further comprising: a light source (150) configured to indicate the status of the security device (100).

12A. The security device (100) according to any preceding clause, wherein: the cover (130) comprises a plurality of shells, each shell having a selected strength profile.

13A. The security device (100) according to any preceding clause, wherein: the adhesive has a dielectric constant that is low enough to allow transmission of the alarm signal through the cover (130).

14A. The security device (100) according to any preceding clause, wherein: the housing comprises an enclosure (110) configured to protect the determination unit (122) and the control unit (123).

15A. The security device (100) according to clause 14A, wherein: the cover (130) is configured to protect a first antenna; and the enclosure (110) is configured to protect a second antenna, wherein the second antenna is a short-range antenna.

16A. The security device (100) according to any preceding clause, wherein: the cover (130) is shaped to resist external stress forces.

17A. A kit of parts comprising: a security device (100) according to any preceding clause; and a mount (200) configured to be mounted with the security device (100), and further configured to be secured to the object (300).

18 A. The kit of parts according to clause 17A, wherein the mount (200) comprises: a clamp (210) configured to secure the security device (100) to a part of a vehicle (300).

19 A. The kit of parts according to clause 17A or clause 18 A, wherein the mount (200) comprises: a lock (220, 230) configured to restrict movement of a component of a vehicle (300).

20A. The kit of parts according to any one of clauses 17A to 19A, further comprising: a locking mechanism of the security device (100) which is configured to be received by the mount (200) to provide a releasable connection between the security device (100) and the mount (200).

21 A. The kit of parts according to clause 20A, wherein: the security device (100) and the mount (200) are configured to be connected together by the locking mechanism, by bringing a surface of the security device (100) into contact with a corresponding surface of the mount (200), and then rotating the security device (100) relative to the mount (200). 22A. The kit of parts according to clause 20A or clause 21 A, wherein: the locking mechanism is configured to release the security device (100) from the mount (200), if the security device (100) receives an instruction from the mobile device (400).

The following clauses form part of the description, and correspond to the claims of the priority application GB2312921.6.

IB. A security device (100) configured to be secured to an object (300), the security device (100) comprising: an enclosure (110) which is strong enough to protect electronic components (121b, 122, 123, 124b) of the security device (100); a backup antenna (121b, 124b) that is located inside of the enclosure (110); a main antenna (121a, 124a) that is located outside of the enclosure (110); and a cover (130) configured to protect the main antenna (121a, 124a), wherein the cover (130) is transparent to radio waves.

2B. The security device (100) according to clause IB, wherein: the cover (130) comprises a composite material.

3B. The security device (100) according to clause IB or clause 2B, wherein: the cover (130) has a dome shape configured to resist external stress forces.

4B. The security device (100) according to any preceding clause, wherein: the enclosure (110) includes a hole through which the backup antenna (121b, 124b) can transmit radio waves.

5B. The security device (100) according to clause 4B, wherein: the enclosure (110) comprises a filler material which prevents access to the electronic components (121b, 122, 123, 124b) via the hole.

6B. The security device (100) according to clause 5B, wherein: the filler material includes a plurality of ceramic beads.

7B. The security device (100) according to any one of clauses 4B to 6B, wherein: the main antenna (121a, 124a) is connected to the electronic components (122, 123) by a wire (125) that passes through the hole.

8B. The security device (100) according to any preceding clause, further comprising: a first circuit board (120a) that is located outside of the enclosure (110), which is configured to provide an electrical connection to the main antenna (121a, 124a); and a second circuit board (120b) that is located inside of the enclosure (110), which is configured to provide an electrical connection to the backup antenna (121b, 124b).

9B. The security device (100) according to any preceding clause, wherein: the main antenna and the backup antenna each includes: a sensor (121a; 121b) configured to sense a status of the security device (100); and a transmitter (124a; 124b) configured to transmit the alarm signal to a mobile device (400).

10B. The security device (100) according to any preceding clause, wherein: the electronic components include: a determination unit (122) configured to determine the status of the security device (100), based on an output of the main antenna (121a) or the backup antenna (121b); and a control unit (123) configured to issue an alarm signal in response to the determination unit (122) determining the status of the security device (100).

1 IB. The security device (100) according to any preceding clause, further comprising: an input port (111) configured to receive the electrical current that flows through a wire (350) that is configured to be secured to the object (300).

12B. The security device (100) according to clause 1 IB, wherein: the input port (111) includes a magnetic connector configured to maintain the electrical connection between the security device (100) and the wire (350).

13B. The security device (100) according to any preceding clause, wherein: the cover (130) comprises a plurality of shells, each shell having a selected strength profile.

14B. The security device (100) according to any preceding clause, further comprising: a locking mechanism configured to engage with a mount (200), to provide a releasable connection between the security device (100) and the mount (200).

15B. The security device (100) according to clause 14B, wherein: the security device (100) and the mount (200) are configured to be connected together by the locking mechanism, by bringing a surface of the security device (100) into contact with a corresponding surface of the mount (200), and then rotating the security device (100) relative to the mount (200).

16B. The security device (100) according to clause 14B or clause 15B, wherein: the locking mechanism is configured to release the security device (100) from the mount (200), if the security device (100) receives an instruction from the mobile device (400).

17B. The security device (100) according to any one of clauses 14B to 16B, wherein the mount (200) comprises: a lock (220, 230) configured to restrict movement of a component of a vehicle (300).

18B. The security device (100) according to any preceding clause, further comprising: a power surge protector (127) configured to prevent an electrical supply from flowing to electronic components of the security device (100) if the power surge protector (127) determines that the electrical supply is above a threshold value of current, voltage or power.

19B. The security device (100) according to any preceding clause, further comprising: a thermal sensor (126) configured to initiate an alert if a temperature is detected above a threshold value.

1. A security device configured to be secured to an object, the security device comprising:
an enclosure configured to protect electronic components of the security device;
a main antenna that is located outside of the enclosure, wherein the main antenna comprises:
a sensor configured to sense a status of the security device wherein the sensor is configured to detect a location of the security device or an impact force received by the security device, and
a transmitter configured to transmit the alarm signal to the mobile device; and
a cover configured to protect the main antenna (121a, 124a), wherein the cover is transparent to radio waves.

2. The security device according to claim 1, wherein: the cover comprises a composite material formed from a number of layers of material and an adhesive

3. The security device according to claim 1, wherein:
the cover has a dome shape configured to resist external stress forces by dissipating any impact forces that are received by the cover.

4. (canceled)

5. The security device according to claim 3, wherein:
the enclosure comprises a filler material which prevents access to the electronic components via a hole.

6. The security device according to claim 4, wherein:
the filler material includes a plurality of ceramic beads.

7. (canceled)

8. The security device according to claim 1, further comprising:
a first circuit board that is located outside of the enclosure, which is configured to provide an electrical connection to the main antenna; and
a second circuit board that is located inside of the enclosure.

9. The security device according to claim 1, wherein: the electronic components further comprise:
a determination unit configured to determine the status of the security device; and
a control unit configured to issue the alarm signal in response to the determination unit determining the status of the security device.

10. The security device according claim 9, further comprising:
an input port configured to receive the electrical current that flows through a wire that is configured to be secured to the object.

11. The security device according to claim 9, wherein:
the input port includes a magnetic connector configured to maintain the electrical connection between the security device and the wire.

12. The security device according to claim 1, wherein:
the cover comprises a plurality of shells, each shell having a selected strength profile.

13. The security device according to claim 9, further comprising:
a locking mechanism configured to engage with a mount, to provide a releasable connection between the security device and the mount.

14. The security device according to claim 12, wherein:
the security device and the mount are configured to be connected together by the locking mechanism, by bringing a surface of the security device into contact with a corresponding surface of the mount, and then rotating the security device relative to the mount.

15. The security device according to claim 12, wherein:
the locking mechanism is configured to release the security device from the mount, if the security device receives an instruction from the mobile device (400).

16. (canceled)

17. The security device according to claim 12, wherein:
the locking mechanism comprises one or more magnets configured to engage the security device with the mount.

18. The security device according to claim 12, wherein the mount comprises:
a lock configured to restrict movement of a component of a vehicle.

19. (canceled)

20. The security device according to claim 1, further comprising:
a thermal sensor configured to initiate an alert if a temperature is detected above a threshold value.

21. The security device according to claim 1, further comprising:
a housing configured to restrict access to the main antenna, the housing comprising the cover and a layer of fibres including fibres that are arranged loosely enough for each of the fibres to move relative to one another.

22. The security device according to claim 1, wherein:
the enclosure includes a number of strips of composite material.

23. The security device according to claim 1, further comprising:
a storage compartment configured to hold security ink that will be released if the security device is attacked.

24. A system comprising a plurality of the security device of claim 1, wherein each security device of the plurality of security devices is configured to communicate with one another.

25. The system according to claim 24, further including a number of global positioning satellite trackers, each global positioning satellite tracker being used to monitor the location of an object.
